(19) United States
(12) Patent Application Publication
(10) Pub. No.: US 2014/0316892 A1
(43) Pub. Date: Oct. 23, 2014

(54) SERVING PROMOTIONS TO MOBILE COMPUTING DEVICES BASED ON WIFI ACCESS POINT PRESENCE

(71) Applicants: ISRAEL L'HEUREUX, MONACO (MC); MARK D. ALLEMAN, PORTLAND, OR (US)

(72) Inventors: ISRAEL L'HEUREUX, MONACO (MC); MARK D. ALLEMAN, PORTLAND, OR (US)

(21) Appl. No.: 14/217,246

(22) Filed: Mar. 17, 2014

Related U.S. Application Data
(60) Provisional application No. 61/800,131, filed on Mar. 15, 2013.

(51) Int. Cl. G06Q 30/02

(52) U.S. Cl. CPC G06Q 30/0259; G06Q 30/0267
USPC 705/14.55; 705/14.57

(57) ABSTRACT

A promotion system for serving ads is provided. The system may include an ad server and a WIFI access point configured to establish wireless connections with mobile computing devices of users via a WLAN, and execute a local captive server that serves to the mobile client devices a graphical user interface. The graphical user interface is configured to register users with the ad server device to receive advertisements, and store profile data about the users in a database associated with the ad server. The ad server includes an ad creation interface configured to enable an advertiser to distribute an advertisement to the mobile computing devices of users who have been detected at the WIFI access point.

### CROSS REFERENCE TO RELATED APPLICATION

This application is based on and claims priority under 35 U.S.C. §119 to U.S. Provisional Patent App. Ser. No. 61/800,131 filed Mar. 15, 2013, entitled RESTAURANT PROMOTIONS, the entire disclosure of which is hereby incorporated by reference.

### BACKGROUND

Numerous channels for distribution of advertisements exist, including broadcast advertising on television and radio, and keyword search based advertising on the internet. These channels can be used to reach massive audiences simultaneously, or to reach individual users who search for a combination of search terms individually. However, one drawback of these channels is that they do not offer the proprietor of a hospitality establishment such as a restaurant an effective tool to advertise to the customer base for that restaurant.

### SUMMARY

A promotion system for serving ads is provided. The system may include an ad server and a WIFI access point configured to establish wireless connections with mobile computing devices of users via a WLAN, and execute a local captive server that serves to the mobile client devices a graphical user interface. The graphical user interface is configured to register users with the ad server device to receive advertisements, and store profile data about the users in a database associated with the ad server. The ad server includes an ad creation interface configured to enable an advertiser to distribute an advertisement to the mobile computing devices of users who have been detected at the WIFI access point.

This Summary presents only a small selection of the various concepts described in further detail by the Detailed Description and associated drawings, and is not intended to be used to limit the scope of the claimed subject matter.

### BRIEF DESCRIPTION OF DRAWINGS

FIG. 1 is a schematic view of a restaurant promotion system according to one embodiment of the invention.

FIG. 2 is a sample advertising creation interface served to an advertiser using the system of FIG. 1.

FIG. 3 is an example advertisement served by the device.

### DETAILED DESCRIPTION

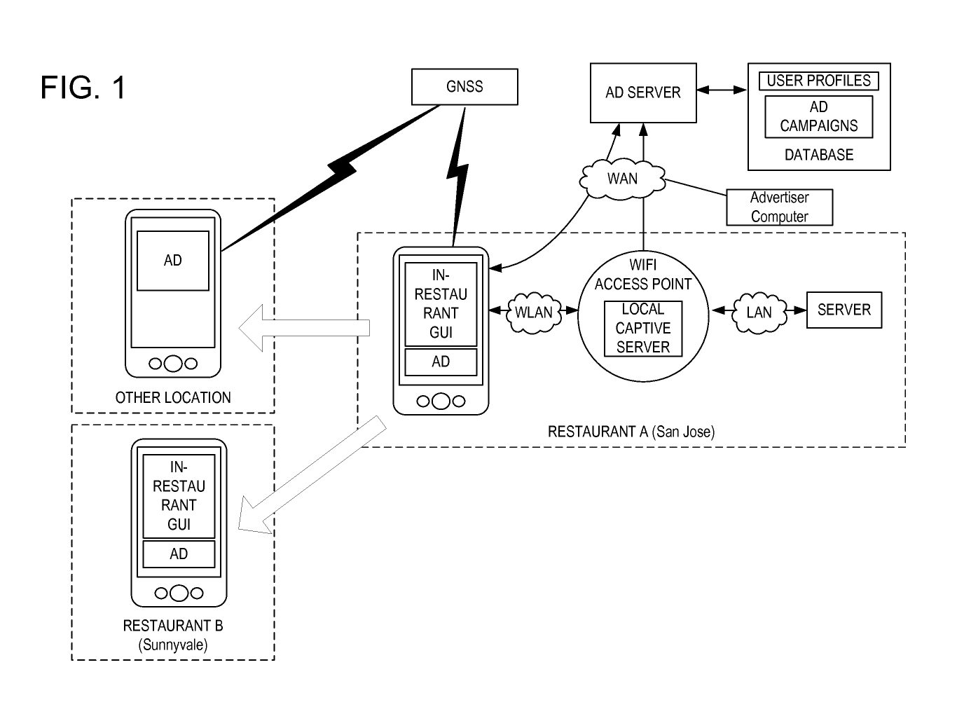

FIG. 1 illustrates a restaurant promotion system for serving ads to customers of a restaurant. The restaurant promotion system includes a WIFI access point configured with a local captive server that is configured to establish wireless connections with mobile computing devices of users via a WLAN, and serve to the mobile client devices an in-restaurant graphical user interface. Via this in-restaurant graphical user interface, users may register with an ad server to receive advertisement related to the restaurant, and profile data about the users is stored in a database associated with the ad server. The local captive server captures the MAC address of the each mobile device and stores it in the user profile data. The in-restaurant GUI may query additional data of the user, such as mobile telephone number, gender and age, if desired.

It should also be noted that the local captive server WIFI access point also logs all MAC addresses for mobile computing devices that come within range of the access point, even if the devices do not establish connections and attempt to connect to the local captive server. Further details about capturing MAC addresses are described in co-pending U.S. patent application Ser. No. 13/242,437, filed Sep. 23, 2011, the entire disclosure of which is herein incorporated by reference.

In this manner customers who frequent a restaurant may sign up to receive promotions from the restaurant. To entice the users to sign up for promotions, in-restaurant signage may communicate to customers, for example, that if the customers log on to the restaurant WIFI router and access the local captive server and register with the service, then a coupon will be delivered to the user, via the mobile client device. In this manner, a user may receive a free menu item, etc., for signing up. As the user travels to other restaurants owned by the same proprietor, the user may interact with a similar system in each restaurant, and the user's presence at each restaurant, as detected via the MAC address being communicated to the WIFI access point in each respective restaurant, is transmitted to the ad server and stored in the user's profile.

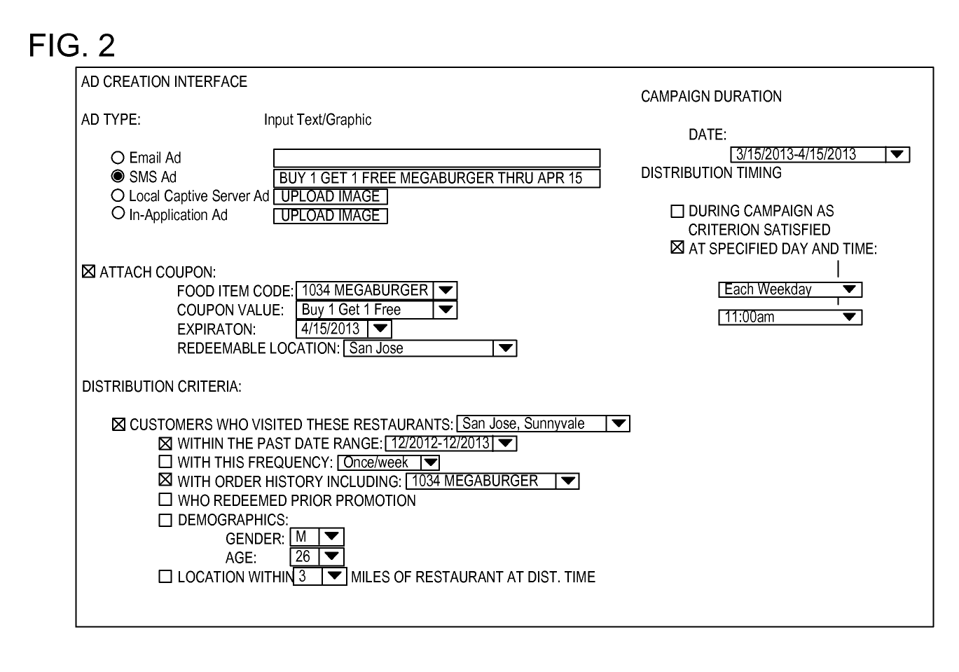

By signing up a number of users that frequent a particular restaurant in this manner the owner of the restaurant may create ad campaigns that are directed to this customer base. To that end, FIG. 2 illustrates an ad creation interface run on an advertiser computer, to enable a restaurant proprietor to create an ad campaign. As shown, the ad creation interface includes a variety of selectors to input ad criteria. An ad type selector enables the advertiser to select from among an email ad, SMS ad, local captive server ad, and in-application ad. The local captive server ad is an ad that is served via the in-restaurant GUI to users who are connected to the local captive server. The in-application ad is an ad that is served to a proprietor supplied application that is run on the user's mobile computing device. When the application is launched by the user, it requests available ads from the ad server of the system of FIG. 1.

The ad creation interface further includes a mechanism to attach an electronic coupon to the ad. The advertiser may enter a food item code, coupon value, expiration date, and redeemable location for the coupon. This information may be stored as metadata associated with an electronic coupon that is distributed to the user's mobile computing device along with or embedded in the advertisement.

The ad creation interface also includes distribution criteria selection tools that enable an advertiser to input various parameters that define the customers to whom the advertisement should be distributed. For example, the tool enables the advertiser to select to distribute an advertisement to customers who have been detected at one or more of a plurality of restaurants. The customer's presence at the defined restaurants is typically detected as discussed above. The advertiser may further specify, via the tool, that presence must be detected within a predefined period of time in the past, such as a period of months or days or years. Further, tool is configured to enable the advertiser to specify that the customers had an order history at the restaurant including specific food or beverage items. Order history may be maintained in the users profile by uploading the order history of the user at each of the restaurants to the ad server database and storing it in the user's profile. These orders may be placed by the application on the user's mobile computing device, for example, or may be placed via point of sale devices in the restaurant that also detect the user's MAC address or otherwise receive an ID associated with the user in order to associate the order with the correct user profile.

The tool is also configured to enable the advertiser to select to distribute the advertisement to customers who have redeemed promotions from the same advertiser in the past, to customers who match certain demographic criteria such as gender and age ranges, and/or to customers who are determined to be located within a predefined distance of the restaurant at which the promotion is redeemable, at the time the ad is distributed. This location may be determined by, for example, detecting that the user has launched the application on the user mobile computing device, detecting the GPS coordinates of the mobile computing device (which may be a GPS enabled smartphone, for example), and transmitting those GPS coordinates to the ad server for matching with the specified geographic range in which the ad is to be distributed.

The ad creation interface may further include a campaign duration input field, to enable the advertiser to input a period of days, weeks, or months, for example, during which to run the ad. The ad creation interface may further include a distribution timing input selector configured to input a desired timing for the ad to be distributed to users. For example, the distribution timing input selector may be configured to enable a selection between sending ads out as the ad criteria are matched by registered customers, or to sending out ads at specific combinations of days/dates/times to those same registered customers who match the specified criteria.

It will be appreciated that the inputs shown in FIG. 2 may generate an SMS ad for BUY 1 GET 1 FREE MEGABURGER THRU APR 15, which includes an accompanying e-coupon redeemable at the San Jose Burgeropolis, through 4/15/2013 for a free Megaburger, if one is purchased. These SMS ads will be sent to the registered mobile telephone number of customers whose mobile device presence has been detected at either the San Jose or Sunnyvale Burgeropolis establishments between December 2012 and December 2013, and who have ordered at one time or another a Megaburger. The advertiser has not selected to limit the distribution to a certain frequency of visits (such as once a week), nor has the advertiser selected to limit the distribution by age, gender or detected location. The ad is set to be distributed at 11 am each weekday, presumably in order to attract the customer to visit the San Jose Burgeropolis for lunch.

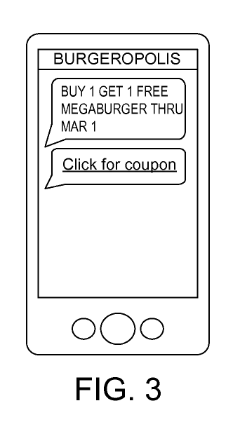

FIG. 3 shows an example SMS ad distributed in this manner. The user may click on the link to request and receive from a remote coupon server (or from the ad server itself) a unique redeemable coupon code that can be communicated at the point of sale to the sales attendant, for entry into the POS system in order to redeem the coupon.

The various configurations and/or techniques described herein are exemplary in nature. Disclosed implementations, embodiments, or examples are not to be considered in a limiting sense, because numerous variations are possible. For example, the systems described herein could be applied to various types of stores, in addition to restaurants. The methods, processes, and/or functions described herein may represent one or more of any suitable number of processing strategies. The various methods, processes, and/or functions that have been described and/or depicted may be performed in the disclosed sequence, in other sequences, in parallel, or in some cases omitted. The subject matter of the present disclosure includes all novel and non-obvious combinations and sub-combinations of the various configurations and techniques, and other features, functions, acts, and/or properties disclosed herein, as well as any and all equivalents thereof.

1. A promotion system for serving ads, comprising:
an ad server; and
a WIFI access point configured to establish wireless connections with mobile computing devices of users via a WLAN, and execute a local captive server that serves to the mobile client devices a graphical user interface, the graphical user interface being configured to register users with the ad server device to receive advertisements, and store profile data about the users in a database associated with the ad server;
wherein the ad server includes an ad creation interface configured to enable an advertiser to distribute an advertisement to the mobile computing devices of users who have been detected at the WIFI access point.

2. The system of claim 1, wherein the local captive server captures the MAC address of the each mobile device and stores it in the user profile data.

3. The system of claim 1, wherein the graphical user interface queries additional data of the user, including mobile telephone number.

4. The system of claim 1, wherein the graphical user interface is configured to enable a user to sign up to receive promotions.

5. The system of claim 1, wherein the ad server is configured to send an ad in the form of a coupon to the user, via the mobile client device, for registering.

6. The system of claim 1, wherein the WIFI access point is one of a plurality of WIFI access points installed in a corresponding plurality of restaurants, and wherein each WIFI access point is configured to detect the presence of a mobile device of the user at each restaurant, as detected via the MAC address for the mobile device being communicated to the WIFI access point in each respective restaurant, and transmit this presence data to the ad server for storage in the user's profile.

7. The system of claim 1, wherein the ad creation interface includes ad type selector that enables the advertiser to select from among an email ad, SMS ad, local captive server ad, and in-application ad.

8. The system of claim 1, wherein the ad creation interface further includes a mechanism to attach an electronic coupon to the ad.

9. The system of claim 1, wherein the metadata indicating a food item code, coupon value, expiration date, and redeemable location for the electronic coupon is attached to the electronic coupon when the electronic coupon that is distributed to the user's mobile computing device along with or embedded in the advertisement.

10. The system of claim 1, wherein the ad creation interface includes distribution criteria selection tools that enable an advertiser to input parameters that define the customers to whom the advertisement is to be distributed.

11. The system of claim 10, wherein the parameters include that presence must be detected within a predefined period of time in the past.

12. The system of claim 10, wherein the parameters include that the user had an order history at a restaurant including specific food or beverage items, the order history for users being stored in the user's profile by uploading the order history of the user at each of the restaurants to the ad server database and storing it in the user's profile.

13. The system of claim 1, wherein the ad creation interface is configured to enable the advertiser to select to distribute the advertisement to customers who have redeemed promotions from the same advertiser in the past, to customers who match certain demographic criteria such as gender and age ranges, and/or to customers who are determined to be located within a predefined distance of the restaurant at which the promotion is redeemable, at the time the ad is distributed.

14. The system of claim 13, wherein the detected location is determined by, for example, detecting that the user has launched the application on the user mobile computing device, detecting the GPS coordinates of the mobile computing device, and transmitting those GPS coordinates to the ad server for matching with the specified geographic range in which the ad is to be distributed.

15. The system of claim 1, wherein the ad creation interface further includes a distribution timing input selector configured to input a desired timing for the ad to be distributed to users.

16. The system of claim 1, wherein the ad is an SMS ad which includes an accompanying electronic coupon.

17. The system of claim 16, wherein the electronic includes a unique redeemable coupon code that can be entered into a POS system in order to redeem the coupon.
